(19) United States
(12) Patent Application Publication
(10) Pub. No.: US 2006/0168225 A1
(43) Pub. Date: Jul. 27, 2006

(54) Network and a distributed electronic commerce system using the network

(76) Inventors: John Gunning, Atlanta, GA (US); Michael James Breaux JR., Athens, GA (US)

Correspondence Address: Eduardo M. Carreras, 6201 Indian River Drive, Norcross, GA, 30092, US

(21) Appl. No.: 10/977,111

(22) Filed: Oct. 29, 2004

(51) Int. Cl. G06F 15/173

(52) U.S. Cl. 709/226; 709/238; 709/240

(57) ABSTRACT

A distributed network for effecting content search requests and processing of transactions is disclosed. The network has application to processes for conducting electronic commerce transactions.

### FIELD OF THE INVENTION

This invention relates to a network for delivering data; and processes, systems and machines for transacting electronic commerce through the network. More specifically it relates to an electronic commerce application that uses peer-to-peer file sharing technologies for effecting the content management and data transfer through the network.

### BACKGROUND OF THE INVENTION

A network is a group of two or more computer systems linked together. Computer networks and their use in the transfer of data have been known for some time. The theoretical foundations for the internet were laid out in a memorandum by Paul Baran in August 1964 titled “On Distributed Communications: 1. Introduction to Distributed Communications Network.” That memorandum outlined three different network topologies or geometric arrangements of the network (centralized, decentralized and distributed).

To communicate efficiently, computers in a network use a common set of rules and signals (protocol). The protocol determines the type of error checking to be used; what data compression method, if any, will be used; how the sending device will indicate that it has finished sending a message; and how the receiving device will indicate that it has received a message. Programmers may choose from a variety of standard protocols. Existing electronic commerce systems typically use Internet Protocol (IP) usually combined with a higher-level protocol called Transmission Control Protocol (TCP), which establishes a virtual connection between a destination and a source. IP is analogous to a postal system in that it allows the addressing of a package and dropping it in the system without a direct link between the sender and the recipient. TCP/IP, on the other hand, establishes a connection between two hosts so that they can send messages back and forth for a period of time.

Computer networks can be typically classified as falling into one of two broad architectures; peer-to-peer or client/server architecture. Most networks used for electronic commerce have a client server architecture. A server is a computer or device on a network that manages network resources. For example, a file server is a computer and storage device dedicated to storing files. Any user on the network can store files on the server. A print server is a computer that manages one or more printers, and a network server is a computer that manages network traffic. A database server is a computer system that processes database queries.

Servers are often dedicated, meaning that they perform no other tasks besides their server tasks. On multiprocessing operating systems, however, a single computer can execute several programs at once. A server in this case could refer to the program that is managing resources rather than the entire computer.

Electronic commerce as used in this specification refers to all aspects of business and market processes enabled by the Internet and World Wide Web technologies. Electronic commerce can be between two businesses (B2B) transmitting funds, goods, services and/or data, between a business and a customer (B2C) between two consumers (C2C) or any possible combination of the aforementioned entities. Typically a prior art electronic commerce system such as illustrated in FIG. 1 comprises a network 10 (two or more computers linked together) including a plurality of consumer client personal computers 11, having access to the internet 13. The system also includes a commerce server 15 managed by a service provider and a plurality of merchant systems 16 each managed by a merchant that wants to sell its products. The commerce server 15 includes electronic commerce software that enables catalog creation and transaction processing. The typical merchant system 16 may include internal accounting processing and product information and other business data and processing functions. The merchant system 16 also includes a merchant database 17 that stores the merchant content. The commerce server 15 may host the e-commerce application, handle credit and debit transactions and typically host portions of the merchant content in the commerce server database 18. A number of models have emerged that utilize these basic components.

For example, a merchant may in some circumstances host the commerce server on its own network. In this model the consumer would connect to the internet using an Internet service provider (ISP), find the merchant web site and connect to the commerce server operated by the merchant. This model would require the merchant to be responsible for the considerable investment in and operation of the commerce server and related applications. It also requires the consumer to access one merchant's content at a time.

Another model involves the use of a separate entity (commerce service provider or CSP) to operate the commerce server. This would be done for a fee to the merchant and has the advantage of relieving the merchant from the operation of the commerce server. Typical CSP's would include companies, like eBay, and Buy.com. Although the cost to each merchant utilizing a CSP can be reduced, the operation of the commerce server is still expensive and requires the use of powerful but expensive software such as Oracle to power their sites. These companies have to purchase and maintain millions of dollars worth of centralized hardware and software to operate their businesses. In some cases the CSP's have to employ many people to support their product acquisition, customer service, product handling/shipping operations, and build or contract for call centers to provide customer service for order status, shipment status and/or product information. From the prior art it is apparent that existing electronic commerce servers operate in a client server environment requiring significant investment in equipment and service. Examples of these prior art systems are discussed below.

U.S. Pat. No. 6,490,567, (Gregory, Dec. 3, 2002) describes a method for conducting electronic commerce over a network by substantially separating transaction functionality from merchant content. Electronic commerce transaction functionality is provided by a commerce server having a commerce database. The commerce server stores merchant and purchaser profile data and merchant content summaries on the commerce database. The purchaser browses and searches for product and merchant information using the commerce server, and is provided with more detailed information stored at a separate merchant content server system. The purchaser selects products to purchase, and a purchase order is sent to the commerce server. The commerce server initiates the settlement of accounts between the merchant and purchaser, and initiates order fulfillment for the selected product. The separation of transaction functionality and merchant content onto separate servers under the control of a commerce service provider and a merchant, respectively, provides a more efficient and effective way of carrying out electronic commerce over a network.

U.S. Pat. No. 6,591,260 (Schwarzhoff, Jul. 8, 2003) discloses a method and computer system for conducting commercial transactions by the exchange of electronic documents. The computer system includes a transaction services network, which comprises a plurality of transaction servers for providing services to support commercial transactions. Trading partners operate servers which communicate with the transaction services network via the Internet. The electronic documents are exchanged between trading partners engaged in a transaction.

U.S. Pat. No. 6,594,692 (Reisman, Jul. 15, 2003) describes an electronic information transport component that can be incorporated in a wide range of electronic information products, for example magazine collections, to automate the mass distribution of updates, such as current issues, from a remote server to a wide user base having a diversity of computer stations. Advantages of economy, immediacy and ease of use are provided. Extensions of the invention permit automated electronic catalog shopping with order placement and, optionally, order confirmation. A server-based update distribution service is also provided. In addition, an offline web browser system, with hyperlink redirection capabilities, a novel recorded music product with automated update capabilities and an Internet charging mechanism are provided.

U.S. Pat. No. 6,629,079 (Spiegel, Sep. 30, 2003) discloses a computer system for conducting electronic commerce including multiple servers.

Peer-to-Peer (P2P) refers to a topology and architecture of computers in a system. Typically, the “Peers” are personal computers (PCs) used by consumers to do ordinary tasks such as word processing, e-mail, internet access, web browsing and the like. These computers in general do not have stable Internet Protocol addresses. A P2P network is one in which two or more PCs share files and access to devices without requiring a separate server computer or server software. One available protocol for establishing P2P networks is Gnutella. The Gnutella protocol is different from a pure P2P architecture in that clients become servers and servers become clients all at once. Basically, anyone can be a client or a server, no matter how big or fast they are. A P2P network utilizing a Gnutella protocol is in effect a distributed environment. A consumer's PC can act as a server to people who want the files on that PC, and acts as a client to access files on other people's PCs. A Gnutella network is made up of many PCs acting as both clients and servers sending files back and forth. All communication is done over the TCP/IP protocol. Each piece of information is called a “packet”, just like in Internet terms.

FIG. 2 illustrates how a P2P network can be established to share files using the existing Gnutella protocol. User A starts with a networked computer 51 that runs one of the Gnutella clients. Computer 51 will work both as a server and a client. User A connects through for example the internet) to another Gnutella-enabled networked computer 52 operated by User B. To connect to the network, User A only has to know the IP address and port of any computer (e.g. computer 52) that is already connected to the network. Computer 51 will send a message announcing User A's existence to computer 52. All communication in a Gnutella network is done over Transmission Control Protocol/Internet Protocol (TCP/IP), the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. Computer 52 will subsequently send a message to computers 53, 54 and 55 announcing the existence of computer 51 in the network. This pattern will repeat with each new level of computers announcing to its neighbors that computer 51 is active on the network. Computer 51 can be designated as node A, computer 52 as node B, computer 53 as node C computer 54 as node D and computer 55 as node E. In networks, a node is a processing location. A node can be a computer or some other device, such as a printer. Every node has a unique network address, sometimes called a Data Link Control (DLC) address or Media Access Control (MAC) address. Each of these Nodes responds to the original announcement with a bit of information about itself: how many files it is sharing, how much space they take up, etc. Once the node A has announced its existence to the rest of the network, the user at this node can now query the contents of the data shared across the network.

A query works in a similar fashion to connecting. Computer 51 transmits a search query 70 through the network. It is propagated by computer 52 through messages 71, 72, and 73. Each computer (e.g. 52, 53, 54 and 55) receiving the message searches the content of its memory or storage device (e.g. 60, 61, 62 and 63) to determine whether a file matching the parameters of the query exists within the content of the memory. If a file exists matching the parameters of the query (e.g. as in memory 63 associated with computer 55) the computer will send a search response message 75 to the computer 52 that sent the query to computer 55. The message will indicate that it has a file that matches the query in its memory 63 and relevant address information. Computer 52 then sends a search response 76 to computer 51.

For file sharing, each computer (52, 53, 54 and 55) acts as a miniature web server using HyperText Transfer Protocol (HTTP), the underlying protocol used by the World Wide Web. HTTP defines how messages are formatted and transmitted, and what actions Web servers and browsers should take in response to various commands. Since the HTTP protocol is well established, existing code libraries can be used. When a search response message 76 is received by computer 51, computer 51 will connect to computer 55 in the same way a web browser would connect to a web server. The file can then be downloaded.

A number of prior art systems have described the use of P2P networks for exchanging files in an electronic commerce setting.

U.S. Patent Application 20020062310 (Marmor, publ. May 23, 2002) discloses A peer-to-peer commerce system that relies on being able to identify the geographic location of the electronic devices, e.g., computers or palm pilots. Where the computer or device is stationary, this can be indicated by inserting a zip code, address or telephone number in the computer code identifying the device. Where the device is mobile, this can be indicated manually in a similar fashion. In addition, global positioning satellite (“GSP”) devices may be incorporated with the device to give geographic location automatically. Further, if the device is a cellular telephone device, the cellular device has location information in terms of identifying the cell in which the device is broadcasting. The peer-to-peer search is passed simultaneously over various branches of a binary tree to applications controlling databases for various businesses. Each business application checks the query against the information on its database and provides it to the requesting computer when available. This system utilizes P2P technology but only to direct consumers to a store where the product can be found.

U.S. Patent Application 20020128935 (White, publ. Sep. 12, 2002) discloses a system that allows for independent authors to upload digital documents (and/or any other binary image) to a searchable database, define the terms of sale and descriptive information, protect document end-use with digital rights management, and retain all intellectual property rights and control at all times. The system also offers both publishers and purchasers the ability to conduct business without the need for individual human contact or disclosure of purchaser or seller contact information.

U.S. Patent Application No. 20020138399 (Hayes, publ. Sep. 26, 2002) discloses a method and system provide an electronic platform that enables any participant in a trading network to trade with any other participant in the trading network according to its own individual trading rules. The system enables retailers, distributors and manufacturers to trade with each other on a peer-to-peer basis. The system includes a central repository connected to the trading network. The central repository does not typically participate directly in trading activities, rather, it supports network activities and maintains information about each of the nodes. Trading activities are conducted on a peer-to-peer basis between the nodes in the network, and nodes obtain information from the central repository when needed. Thus, business transacted between two partners is not known to any node (or the central repository) except the two individual partners themselves.

The advantages of this P2P network are that processing can be distributed (that is allowing users of the network to schedule batch-jobs that are processed by the computers on the network during their idle time thereby decreasing the need for new computing resources); and users are allowed to exchange data directly without storing files on a centralized server. This avoids the need to establish a centralized server and allowing two users to communicate with each other directly.

Java is an object-oriented language simplified to eliminate language features that cause common programming errors. Java source code files (files with a java extension) are compiled into a format called bytecode (files with a .class extension), which can then be executed by a Java interpreter. Compiled Java code can run on most computers because Java interpreters and runtime environments, known as Java Virtual Machines (VMs), exist for most operating systems, including UNIX, the Macintosh OS, and Windows. Bytecode can also be converted directly into machine language instructions by a just-in-time compiler (JIT).

Java is a general purpose programming language with a number of features that make the language well suited for use on the World Wide Web. Small Java applications are called Java applets and can be downloaded from a Web server and run on a computer by a Java-compatible Web browser, such as Netscape Navigator or Microsoft Internet Explorer.

To meet the demand for convenient shopping on the Internet, many on-line shopping sites emerged. Over time, however, only a few achieved early market leadership, such as Amazon.com, Buy.com and AOL. Despite their growing popularity, the business models employed by these companies have inherent inefficiencies that negatively impact their ability to achieve and maintain profitability.

One of the disadvantages of existing Internet Shopping is that it is time consuming and inefficient: Today, consumers must visit a number of different Manufacturer sites to gather comparative data on a particular type of product they want to purchase. It is frustrating and time consuming. As a result, consumers are driven the mega-product sites that offer a wide array of products from different manufacturers.

Another disadvantage of existing sites is that their business models are based on distribution-driven product acquisition, leading to significant stocking and handling costs and inefficiencies: Most Internet resellers are all distribution-driven business models. They purchase products from distributors (who have added their mark-up) and then add their own mark-up. Their business model creates significant product acquisition, stocking, handling and shipping costs for the company/site and restricts their ability to offer lower prices.

Another disadvantage of existing systems is the costs of inventory ownership: Most Internet resellers own and stock their inventory. As a result, they incur warehousing, handling, shipping and other capital costs. This negatively impacts an Internet reseller's ability to offer the best price/value, expand new product offerings, causes delayed or improper shipments, increases delivery time and generates dissatisfied customers.

The typical business model and technology architecture used by existing systems lead to high employee staffing cost: Internet resellers have high staffing levels in order to input product data, staff warehouses, provide order fulfillment and customer service.

Yet another disadvantage of existing systems is that there is no user friendly product comparison functionality: Even though some Internet resellers offer feature, value and price comparisons of the products they sell, most offer only a select range of products (i.e.—electronics or housewares or shoes but not all on the same site). As a result, Internet shoppers have to go to a number of different reseller sites to gather the comparison data they need to make an intelligent buying decision.

Another disadvantage is that there is no pricing and value validation: In most cases, there is little or no validation of product claims on Internet reseller sites, such as links to consumer Union product reports.

Yet another disadvantage of existing systems is that they have a limited supplier base: Internet resellers are limited to product offerings that are stocked by their distributors. On the other hand, eBay offers products listed by its customer. Once the customer sells the product, for example a used computer, eBay has to constantly advertise to attract new sellers since the majority of its users are selling used products and, generally, do not have a replacement to list on the site.

For example, U.S. Pat. No. 6,490,567 discloses a Distributed electronic commerce is conducted over a network by substantially separating transaction functionality from merchant content. Electronic commerce transaction functionality is provided by a commerce server having a commerce database. The commerce server stores merchant and purchaser profile data and merchant content summaries on the commerce database. The purchaser browses and searches for product and merchant information using the commerce server, and is provided with more detailed information stored at a separate merchant content server system. The purchaser selects products to purchase, and a purchase order is sent to the commerce server. The commerce server initiates the settlement of accounts between the merchant and purchaser, and initiates order fulfillment for the selected product. The separation of transaction functionality and merchant content onto separate servers under the control of a commerce service provider and a merchant, respectively, provides a more efficient and effective way of carrying out electronic commerce over a network. This system requires the service provider to store merchant and purchaser profile data and merchant content summaries on a commerce database. This requires significant capital expenses, and maintenance of the data.

### SUMMARY OF THE INVENTION

The disadvantages of the prior art system are overcome by the use of a network wherein the computers in the network use Web Services and XML schemas to communicate content between computers in the network. Web Services describes a standardized way of integrating Web-based applications using the XML, SOAP, WSDL and UDDI open standards over an Internet protocol backbone. XML is used to tag the data, SOAP is used to transfer the data, WSDL is used for describing the services available and UDDI is used for listing what services are available. Web services allow organizations to communicate data without intimate knowledge of each other's IT systems behind the firewall.

Unlike traditional client/server models, such as a Web server/Web page system, Web services do not provide the user with a graphical user interface (GUI). Web services instead share business logic, data and processes through a programmatic interface across a network. The applications interface, not the users. Developers can then add the Web service to a GUI (such as a Web page or an executable program) to offer specific functionality to users.

Web services allow different applications from different sources to communicate with each other without time-consuming custom coding, and because all communication is in XML, Web services are not tied to any one operating system or programming language. For example, Java can talk with Perl, Windows applications can talk with UNIX applications. Web services do not require the use of browsers or HTML. Web services are sometimes called application services.

More specifically, the disadvantages of prior art electronic commerce systems are overcome by the novel the distributed electronic commerce system using peer-to-peer technology of the present invention.

One of the advantages of the network and the electronic commerce application is that it operates as a network with a distributed topology. By removing the need to duplicate and store content of each content provider the service provider does not have to purchase and maintain large databases or complex web-base administration applications. This allows for a significant reduction in overhead costs.

These objects and advantages are achieved by a novel network that provides a first set of content provider computers each of which stores the content the content provider operating the computer. This first set of content provider computers are connected to a gateway and designated as key nodes. A gateway is a node on a network that serves as an entrance to another network. In enterprises, the gateway is the computer that routes the traffic from a workstation to the outside network that is serving the Web pages. In homes, the gateway is the ISP that connects the user to the internet. In enterprises, the gateway node often acts as a proxy server and a firewall. The gateway is also associated with both a router, which use headers and forwarding tables to determine where packets are sent, and a switch, which provides the actual path for the packet in and out of the gateway. A router is a device that forwards data packets along networks. A router is connected to at least two networks, commonly two LANs or WANs or a LAN and its ISP's network. Routers are located at gateways, the places where two or more networks connect. Routers use headers and forwarding tables to determine the best path for forwarding the packets, and they use protocols such as ICMP to communicate with each other and configure the best route between any two hosts. Very little filtering of data is done through routers.

The gateway is accessed by a user computer that is searching for content. The gateway translates and routes the search request to the key nodes along with addresses of a second set of content provider computers that the key nodes should access to further conduct searches for additional content. The key nodes search their own content and forward the search request to the second set of content provider computers (designated as secondary nodes) as requested by the gateway. Results from the secondary nodes are forwarded to the primary nodes and reported back to the gateway with the results of the primary nodes. The results are consolidated and reported back to the user initiating the search. Thus each content provider is responsible for storing and duplicating their own content. The service provider need only maintain a list of content provider addresses. Again, this reduces the need for expensive resources.

This network can provide significant advantages in an electronic commerce application.

By using the gateway to effect a search, the consumer will see product information from all manufactures that make and offer products of the type desired by the consumer for sale direct to the consumer.

The gateway technology of the present invention effectively and efficiently separates two networks: Consumer and Manufacturer. The gateway technology also provides a mechanism for communication between each

By moving most of the client-side work to the consumer application, the company does not need extensive web and application servers. Also, does not need the human capital to maintain these servers

For the consumer the system of the present invention provides the advantage of being able to shop all manufacturers for a given product for free (access to all participating manufacturers). The consumer can filter results according to product features. Further the system enables manufacturers to sell directly to the consumer with the product being dropped shipped to the consumer's specified location.

For the manufacturer, the system of the present invention avoids the need for separate data for its enterprise systems and electronic commerce systems. The manufacturer can use existing product databases to synchronize with the system of the present invention. Additionally because the manufacturer is selling directly to the consumer the manufacturer has control over the sale price paid by consumer. Because transactions are processed using credit cards there is a reduction in receivable time and delinquent purchases. The system of the present invention provides the manufacturer with an alternative distribution channel at significantly reduced cost. It also provides the manufacturer with greater control over products and accessories available for sale.

By using P2P technology the system of the present invention reduces the strain of network bandwidth on the electronic commerce service provider and it may further reduce network use by exploiting affinities among manufacturers that permit efficient routing of queries for product information.

With these and other advantages and features of the invention that will become apparent form this specification, the nature of the invention may be more clearly understood by reference to the following detailed description of the invention, to the appended claims and to the drawings

### BRIEF DESCRIPTION OF THE DRAWINGS

FIG. 1 shows a prior art embodiment of an electronic commerce system.

FIG. 2 shows a representation a decentralized P2P network that may be used to exchange content.

FIG. 3 shows the network of the present invention.

FIG. 4 shows an electronic commerce system in accordance with an embodiment of the present invention.

FIG. 5 shows a flow block diagram of the operations performed by the consumer application.

FIG. 6 shows a flow block diagram of the operations performed by the manufacturer application.

FIG. 7 shows a representation of the manufacturer part of the electronic commerce system of the present invention.

FIG. 8 shows a schematic of the network created by the system of the invention.

FIG. 9 shows a flow block diagram of the operations performed by the Gateway.

FIGS. 10a through 10f illustrate the dynamic creation of an electronic commerce network using the invention.

FIG. 11a through 11g illustrate the operation of the peer-to-peer electronic commerce system.

FIGS. 12 a through 12 c illustrate the consumer to consumer feedback network of the present invention.

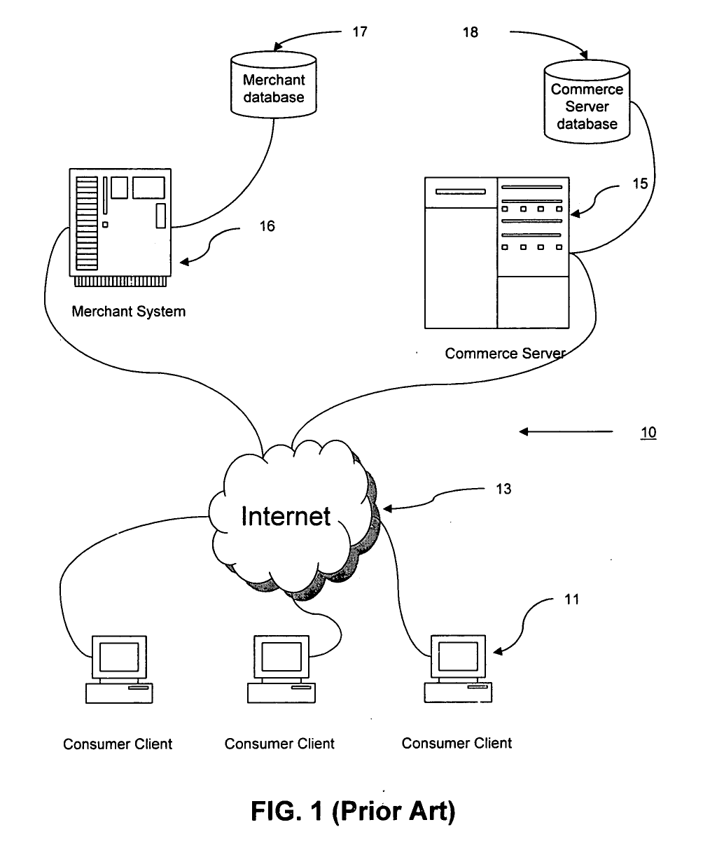

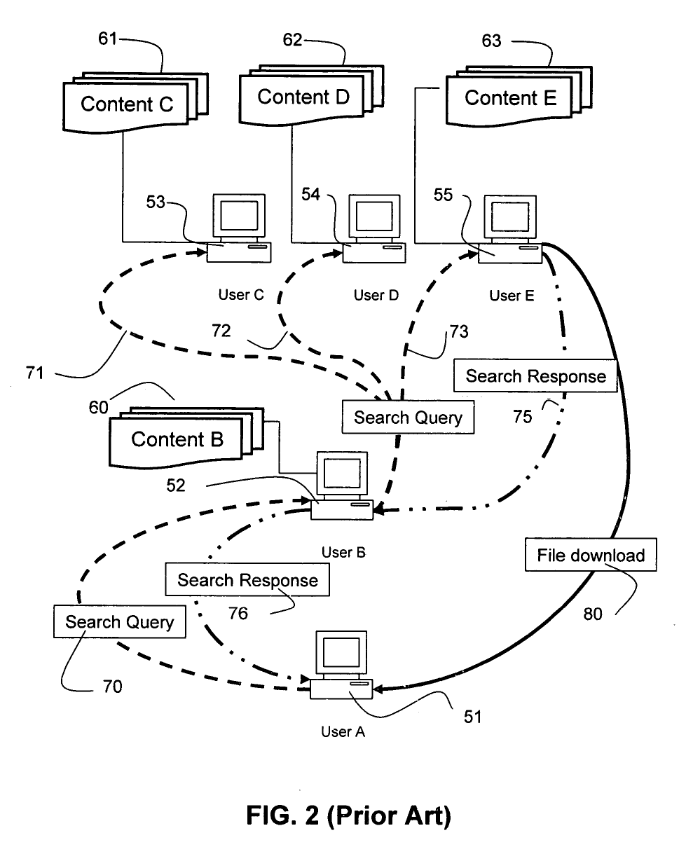

### DETAILED DESCRIPTION

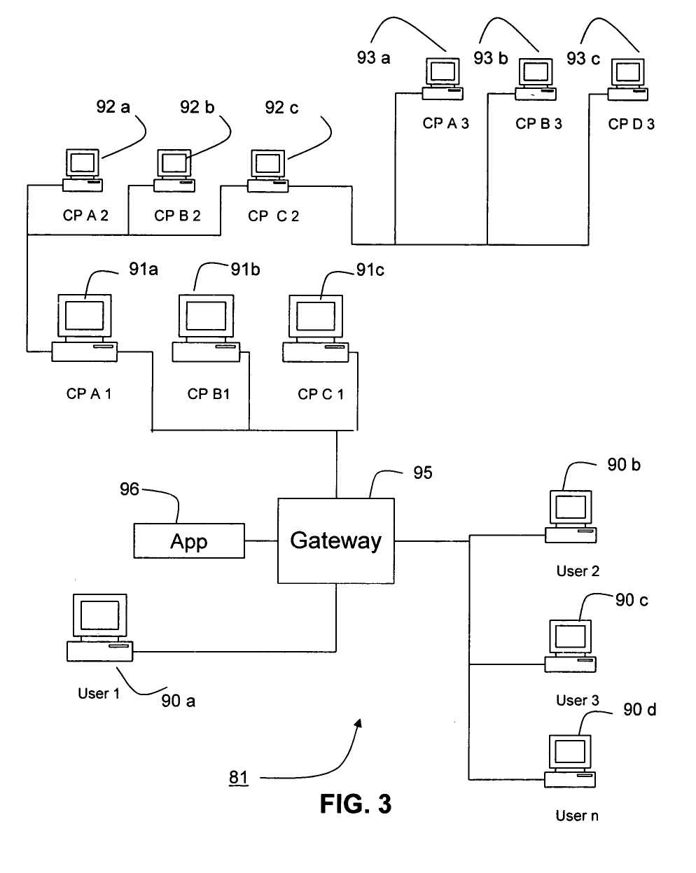

FIG. 3 illustrates a network 81 in accordance with the present invention. The network 81 comprises a plurality of user computers illustrated in FIG. 3 as 90 a, 90 b, 90 c and 90 d each associated with a user (User 1, User 2 User 3 and User n). The network 81 also comprises a first subset of content provider computers 91 a, 91 b, 91 c, etc. each associated with a content provider (CP A1, CP B1, CP C1 respectively). The network 81 also comprises a second set of content provider computers (92 a, 92 b, 92 c etc.) each associated with a content provider (CP A2, CP B2, CP C2 respectively), a third subset of content provider computers (93 a, 93 b, 93 c, etc.) and a plurality of other similar sets of content provider computers.

Each user computer on the network 81 is connected to the network through a gateway 95. This connection may be through various well known means, for example, modem connection through an internet service provider. Each of the first subset of content provider computers (91 a, 91 b, 91 c, etc.) are also connected in a similar fashion to the gateway 95. Each of the first subset of content provider computers 91 a, 91 b, 91 c etc., defines a key node in the network 81. These key nodes are considered the first tier of content provider nodes in the network. At least one of first set of content provider computers (e.g. 91 a) is connected to a second set of content provider computers 92 a, 92 b, 92 c, etc. Each of the second subset of content provider computers 92 a, 92 b, 92 c etc., defines a node in a second tier of the network 81. At least one other of the second subset of content provider computers (e.g. 91 c) may be connected to a third set of content provider computers (93 a, 93 b, 93 c, etc.). Each of the second subset of content provider computers 92 a, 92 b, 92 c etc., defines a node in a second tier of the network 81. As will be apparent, the network 81 may include a plurality of tiers each including a plurality of nodes. Associated with the gateway 95 is an application 96. The application 96 works with the gateway 95 to determine what computers will be connected thereby defining the network. Associated with application 96 is a list of content providers that are allowed access to the network 81 their addresses and information about the architecture of network 81. The information about the architecture of the network 81 would be constantly changing as content providers and users access the network.

When a content provider wants to be connected to the network it will send a message to the gateway 95 requesting connection. The gateway application 96 will check the identification data of the content provider to determine whether it has authorization to connect to the network. The gateway application 96 will then assign a node in the network to the content provider based on the availability of connection by other nodes in the network and the efficiency of the available nodes. The gateway 95 will communicate to the new content provider what node it will be connected to, and the content provider will communicate back to the gateway of the availability of further connections to it. The gateway application 96 will maintain a list of the addresses, the node connections and the availability of further connections. The gateway application 96 will also measure the performance of each node and reassign node connections in a way that optimizes the network performance.

The network operates by cascading search requests though each tier of nodes. For example, if User 1 desires to obtain certain content XYZ, User 1 will connect to the gateway 95 and initiate a search for content XYZ. The gateway 95 maintains a list of addresses of content providers indexed by search criteria. Gateway 95 will then send a message to the first set of computers (91 a, 91 b, 91 c, etc. requesting that each perform a search for XYZ in their contents and requesting that they forward a search request to the second set of content provider computers (92 a, 92 b, 92 c, etc.) instructing those computers to conduct a search of their contents for XYZ. Each content provider computer that finds a match for XYZ returns a copy of the content to the content provider computer instructing the search. So, for example, if computer 92 b finds content that complies with the XYZ search parameters, it will return the content to computer 91 a. Each of the first set of computers 91 a, 91b, 91 c, etc. will return their results to the gateway along with any results received from the second set of content provider computers. The gateway 95 will then return the results to the User 1. At the option of the user (e.g. User 1) the gateway maintains the address of User 1 as associated with a search for XYZ. User 2 can then request from the gateway the address of any user that has conducted a search for XYZ and communicate directly with that user of through the gateway 95.

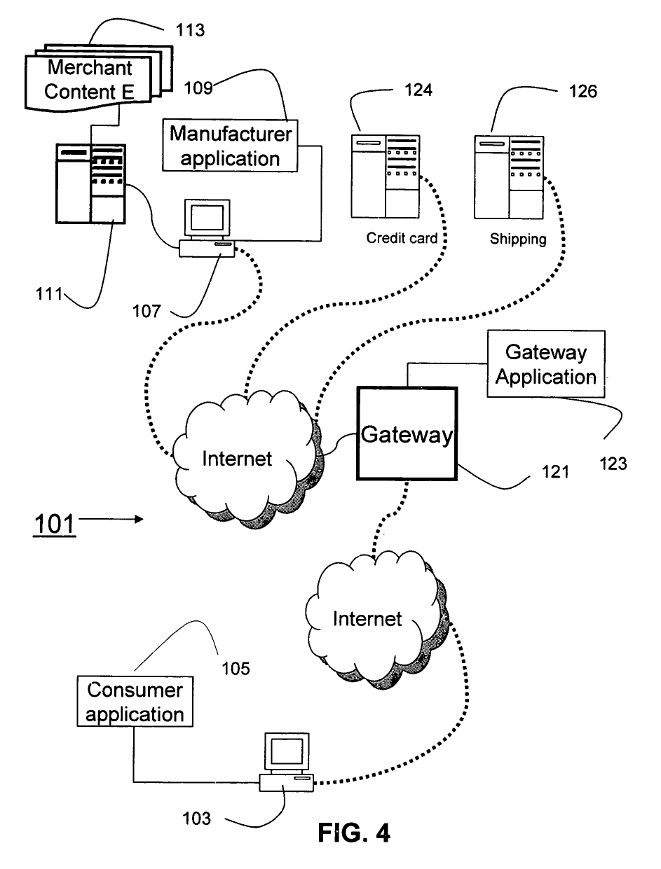

Illustrated in FIG. 4 is an application of the Network 81 in an Electronic Commerce System 101 of the present invention comprises a plurality of consumer personal computers 103 and a consumer application 105, running on each consumer personal computer 103. The Electronic Commerce System further comprises a manufacturer computer 107 running a Manufacturer application 109 which may be connected to the manufacturer's internal systems 111 and associated internal databases 113. The Electronic Commerce System 101 further comprises a Gateway 121 and an associated Gateway application 123 which is described in more detail below. The Electronic Commerce System 101 may also include a credit card processing server 124 and a shipping/fulfillment/tracking server 126 connected to the gateway 121.

The consumer application 105 provides the interface for consumer to connect to the Gateway 121 and search available manufacturers for any product through keyword or product detail drill down menus. If the consumer is unable to connect, the consumer application 105 retries to connect to the Gateway 121. It also provides the interface for retrieved Manufacturer search results, allowing a comparison based on selected features or details. The consumer application 105 also allows the consumer to invoke a buy transaction that occurs at the Gateway application 123. The consumer application 105 also provides interface and Gnutella protocol handling for consumer-to-consumer product information and feedback queries as described in detail below.

Consumer Interaction Process

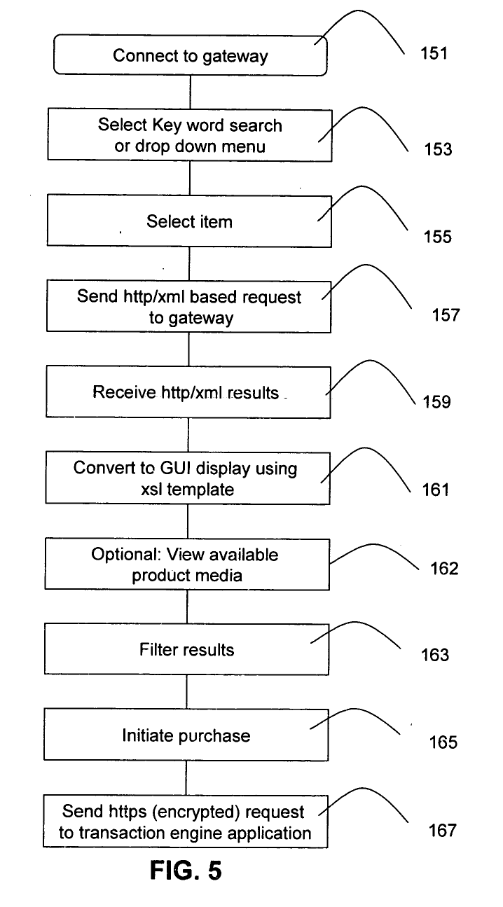

FIG. 5 is a flow diagram that illustrates the basic functions of the consumer application 105 and how the consumer interacts with the network to order Physical and Digital products.

The consumer first instructs the consumer application 105 to connect to the Gateway 121, illustrated in FIG. 5 as connect instruction 151. In the next step consumer search request 153 the consumer uses either (a) a key word search box interface whereby the user types in a specific product item word and clicks search or (b) an item drill down menu. The item drill down menus will be broken down into Category, Department, Product Type, and Item. The user will select at least 3 of the drop down menus to effect a search.

The consumer selects an item by clicking “Search” (Consumer search select step 155) and the consumer application 105 sends an http/xml based request to the Gateway 121, illustrated as step 157. This request is processed by the gateway 121 as described below.

Upon completion of the search the gateway 121 sends the results in http/xml format to the consumer application 105 and the consumer application 105 receives search results in step 159. The next step 161 is to convert the search results to a graphical user interface form using xsl templates to display the search results into an organized presentation. The consumer may opt to view available product media such as advertisements and product manuals in step 162.

The consumer can filter search results according to selected product feature or details in step 163.

To initiate a purchase, the consumer clicks a “buy now” button in step 165 which sends product data through an https (encrypted) request to a transaction engine application. The transaction engine application is a program that validates consumer username/password, retrieves user account and credit card information. The transaction engine application uses a commercially available credit card processing service (e.g. Nova) API to effect transaction and a Shipping/fulfillment/Tracking API (e.g. Fed-Ex) to schedule shipping. An API is a set of routines, protocols and tools for building software applications. Most operating environments provide an API so that programmers can write applications consistent with the operating environment. The transaction engine will send the details of the transaction to the credit card processing service server (124 in FIG. 4). The credit card processing service will charge the credit card and send a notification of success or failure. Upon success, the transaction details are written to the credit card processing service internal database. Next the transaction details are sent to the Consumer and manufacturer through a secure connection. For digital products once the transaction success flag is received, instructions are sent to an in-house media server (which is stocked with all digital products available on the network) to connect to the specific consumer node. The medial server will then interact with components in the consumer application to handle the download of the media file to the Consumer computer. Confirmations are sent to consumer and Manufacturer application through https. For digital products, upon confirm from Nova, a request will be send to a media server with instructions to download to consumer application.

The manufacturer application 109 provides an interface for manual product data entry; and in addition, provides a translation interface that will allow a manufacturer to point to their existing product databases to retrieve the required product detail information. The manufacturer application 109 will save product detail information in a file to be searched later by the Gateway 121 Gnutella based search request initiated by the consumer application 105. The manufacturer application 109 will also provide Gnutella protocol handling to allow for searches initiated by the consumer application 105 through the Gateway 121. Each search request will instruct the key manufacturer node to search the contents of its product detail files and forward the search to other secondary Manufacturer nodes. The manufacturer application 113 will initially communicate with the Gateway 121 for network connection parameters. Once received, the manufacturer application 113 will constantly update the Gateway 121 on its connection status and the status of local nodes (nodes connected directly to the manufacturer application 113).

The manufacturer application 113 will search and retrieve data about three subjects: (1) manufacturer identification (Manufacturer ID); (2) manufacturer product data; and (3) manufacturer financial transaction data (i.e. where is the money sent). This in effect creates a manufacturer network by linking the nodes searches of manufacturers of the same Item Tag to make the search of the manufacturer network faster and more efficient.

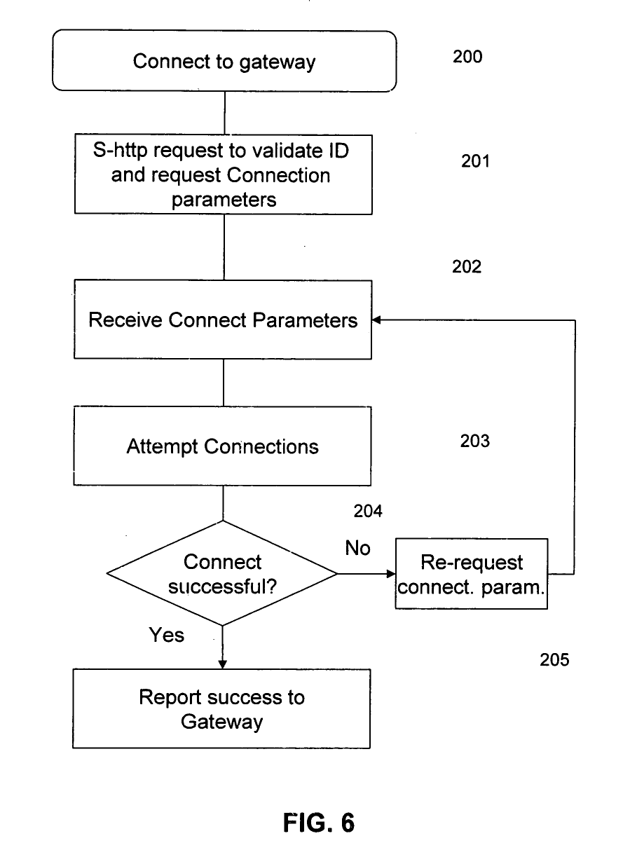

FIG. 6 is a flow diagram that illustrates the basic functions of the manufacturer application 109 and how the manufacturer interacts with the network to receive and fulfill orders for physical and digital products. Initially, in step 200, the manufacturer application 109 connects to the Gateway 121. The manufacturer application 109 then sends a secure http (S-http) request to gateway to validate the ID of the manufacturer application 109 and to ask for connection parameters. S-http is a protocol for transmitting data securely over the internet. S-http is designed to transmit individual messages securely.

Manufacturer application 109 then receives connect parameters (names and addresses of available nodes) in step 202. The manufacturer application then attempts those connections with other manufacturer computers in step 203.

Manufacturer application 109 determines the success or failure of connection attempts in step 204. If the connection fails, then the manufacturer application 109 re-requests connection parameters from gateway in step 205. Upon successful connection the manufacturer application 109 reports the success to the Gateway 121. The node connected to also sends a status update to the gateway.

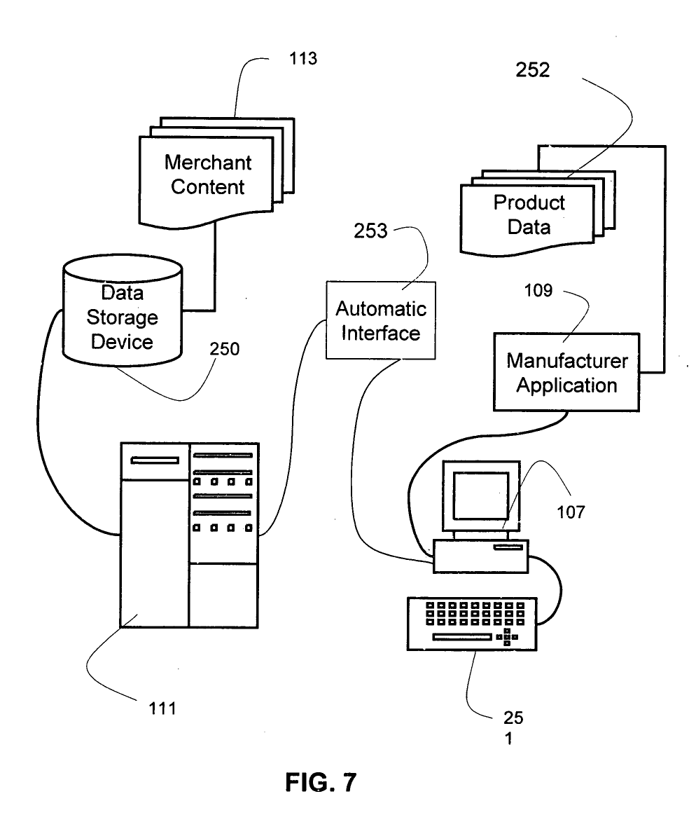

FIG. 7 illustrates how product data is handled by the manufacturer. The manufacturer may manually enter product data using an input device such as a keyboard 251 into a product database 252. Manual interface whereby user types in each required field for a given product. The data is saved into a proprietary file format in database 252 accessed by the manufacturer application 109. Alternately, an automatic interface 253 may be used to extract product data from the merchant content 113 stored in the data storage device 254 associated with the manufacturer internal systems 111. The automatic interface 253 may use Java to extract relevant data from the merchant content 113 for a given product and then converts or translates it to a proprietary file format in database 252. Each data translation is saved for future use.

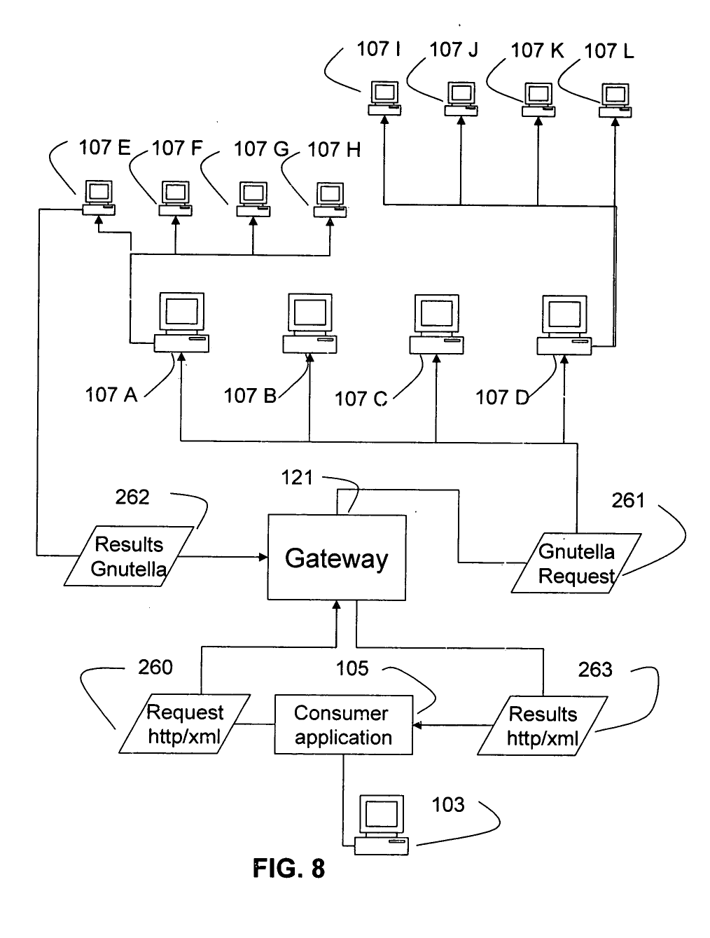

FIG. 8 illustrates the operation of the Gateway 121. Gateway 121 accepts search requests formatted in http/xml protocol directly from consumer application 105. The Gateway 121 translates the http/xml request into a second protocol (e.g. Gnutella) based request 261 which is sent to a first set of manufacturer computers that comprise a plurality of manufacturer computers 107 A, 107B, 107 C, etc. These manufacturer computers are designated as “Key Manufacturer nodes”. Key nodes (e.g. 107 A, 107 B, 107 C and 107 D) are connected directly to the Gateway 121. The Key Manufacturer nodes 107 A, 107 B, 107 C and 107 D are also connected to a series of other manufacturer nodes. For example, in FIG. 8 node 107 A is illustrated as connected to nodes 107 E, 107 F, 107 G and 107H. Associated with each manufacturer computer or node is a manufacturer application 109 (not illustrated in FIG. 8, see FIG. 7). Thus each manufacturer computer or node e.g. 107 A through 107 L will have a corresponding manufacturer application 109 A through 109 L. Each manufacturer application 109 (A through L, for example) are assigned their connection parameters that identify which other manufacturer applications 109 are available for connection from the Gateway 121. In essence, the Gateway 121 is building the network intelligently. It analyzes the speed of requests and the architecture of the network and assigns the newcomer to the most efficient place on the network. The Gateway is directly connected to the Key nodes and sends information to the Key nodes about other nodes that are available or the Key nodes to connect to

The Gateway 121 has built the network and receives constant updates about its speed and stability; therefore, when translating a consumer search request into a Gnutella request, the Gateway 121 can set the Time To Live (Time to Live is a field in the Internet Protocol (IP) that specifies how many more hops a packet can travel before being discarded or returned) for each Key Node. In this way, all available manufacturers are searched.

When a Manufacturer application 109 associated with a node requests entry into the network, the Gateway 121 will analyze the encrypted key assigned to each manufacturer application 109 to validate that the manufacturer application 109 is a valid and qualified application. Each appropriate gateway application 109 will execute the search instructed by the consumer and return the results to the Gateway 121.

The search results 262 (for example the result from node 107 E) are returned back to the Gateway 121 in Gnutella format. The gateway application 123 translates the results into an http/xml format 263 which is sent back to the originating consumer application 103.

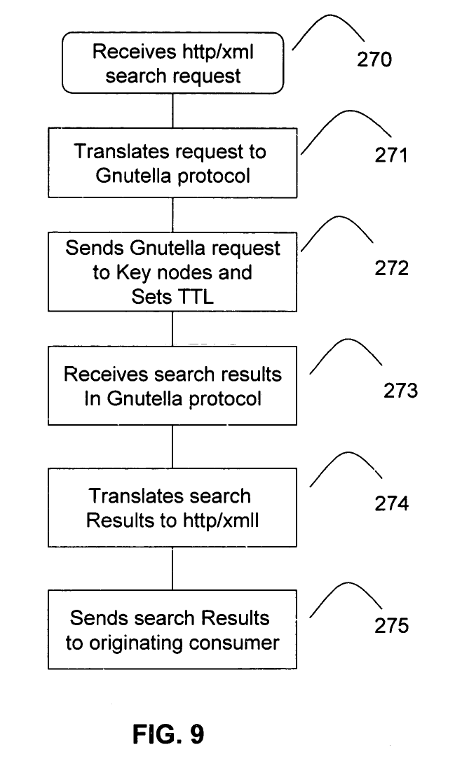

FIG. 9 illustrates the search process at the Gateway 121. The Gateway 121 receives http/xml search request from directly consumer application as shown in step 270. The Gateway application 123 translates the search request data into a Gnutella based search request using Java. The Gateway 121 then sets the TTL for each search request packet and sends the request to a plurality of manufacturer computers 107, each being designated as a Key Node. The gateway 121 then receives the manufacturers' search results in step 273 and using a java application translates it from Gnutella protocol to http/xml in step 274. The gateway 121 then sends the search results to the originating consumer application 109.

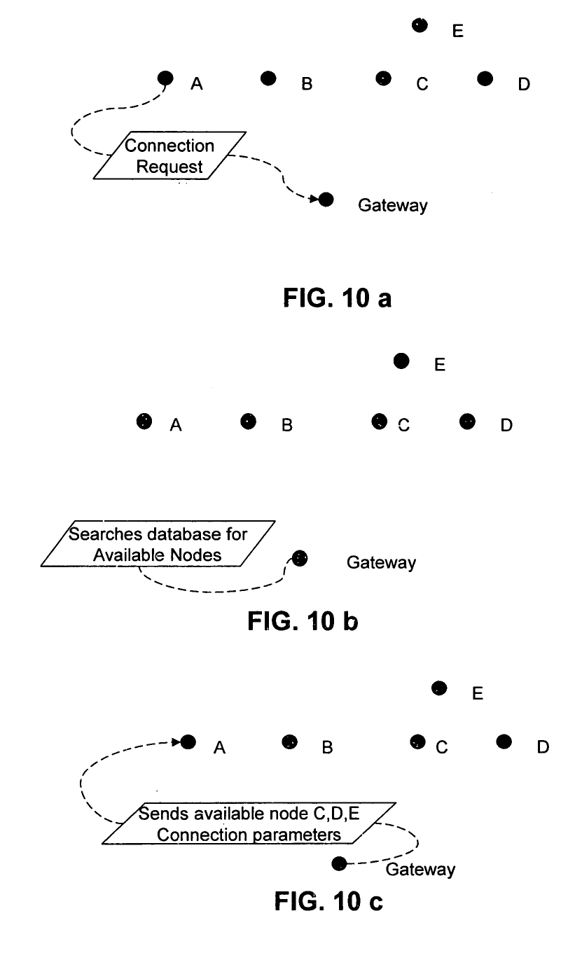

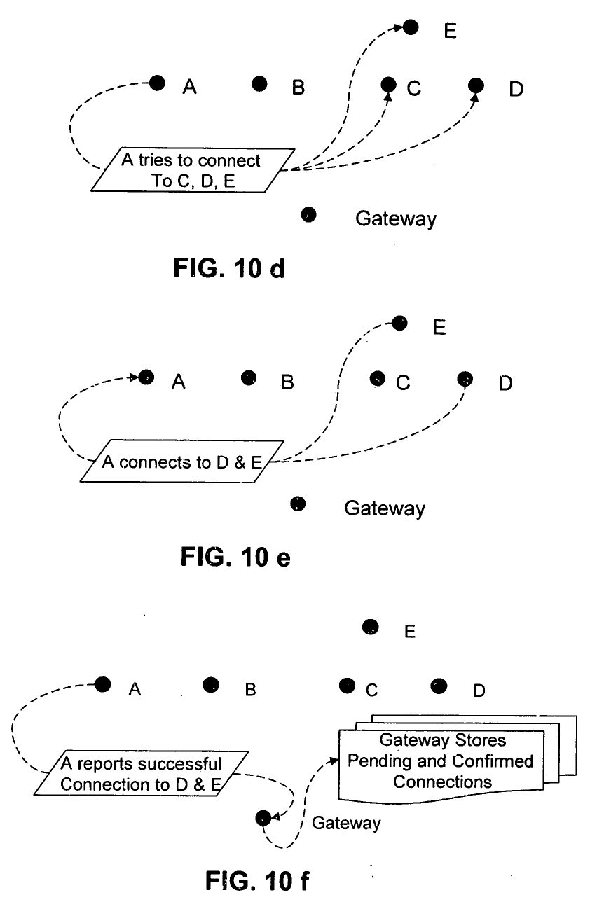

FIGS. 10 a through 10 f illustrate the way the network architecture is created for the electronic commerce system 101. The Figures illustrates a network having for example a Gateway, and nodes A-E. For each node there will be a manufacturer computer 107, a manufacturer application 109 and manufacturer product data 252 (as shown in FIG. 7). For node A, the manufacturer computer is designated as 107a, the manufacturer application is designated as 109a and the product data is designated 252a. Similar designations are used using the letter designating the other nodes to differentiate the computers, applications and product data associated with each node.

In FIG. 10 a, the manufacturer computer 107a in node A sends a connection request to the Gateway 121. The request includes an application ID over https that is encrypted. The Gateway 121 verifies application ID is valid, that is, that the ID and application has been issued by the application provider. The Gateway application 123 searches a database of all authorized IDs and makes a determination of the validity of the ID.

If the ID is valid, the Gateway 121 searches an architecture database at the Gateway 121 for available nodes as illustrated in FIG. 10 b.

Using Java and SQL (structured query language, a standardized query language for requesting information from a database) to search in an architecture database table for nodes with available connections and analyzes for optimal connection. In this example the Gateway determines that nodes C, D, and E are available.

The Gateway 121 sends connection parameters (who to connect to) back to the manufacturer application (109a) using S-http protocol indicating that nodes C, D, and E are available (see FIG. 10 c).

The node A manufacturer application 109a attempts to connect connection to the assigned manufacturer nodes C, D, and E and reports success/failure using http back to the Gateway 121 which logs the information in its architecture database. All pending and confirmed connections are stored so that the Gateway 121 always knows the architecture of the manufacturer network (in this example consisting of the Gateway 121 and nodes A, E and D).

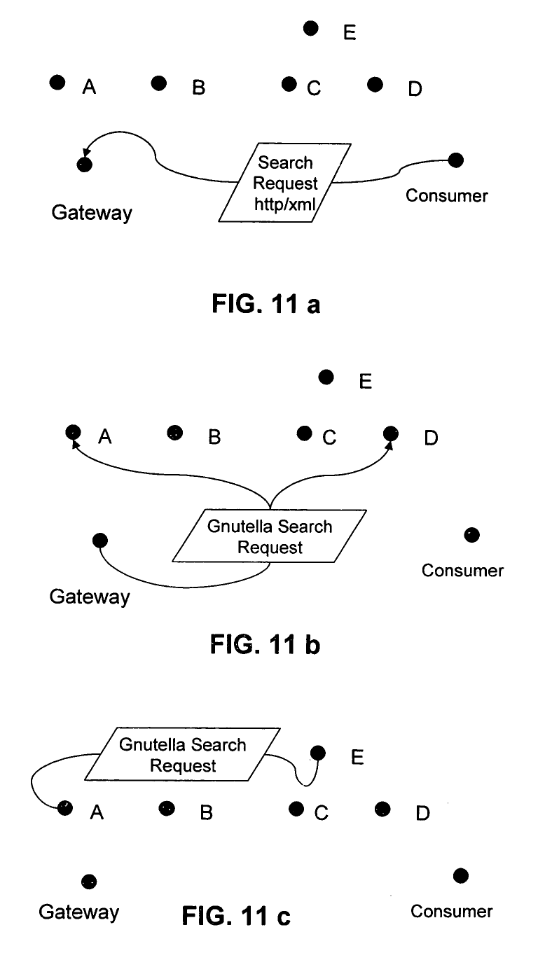

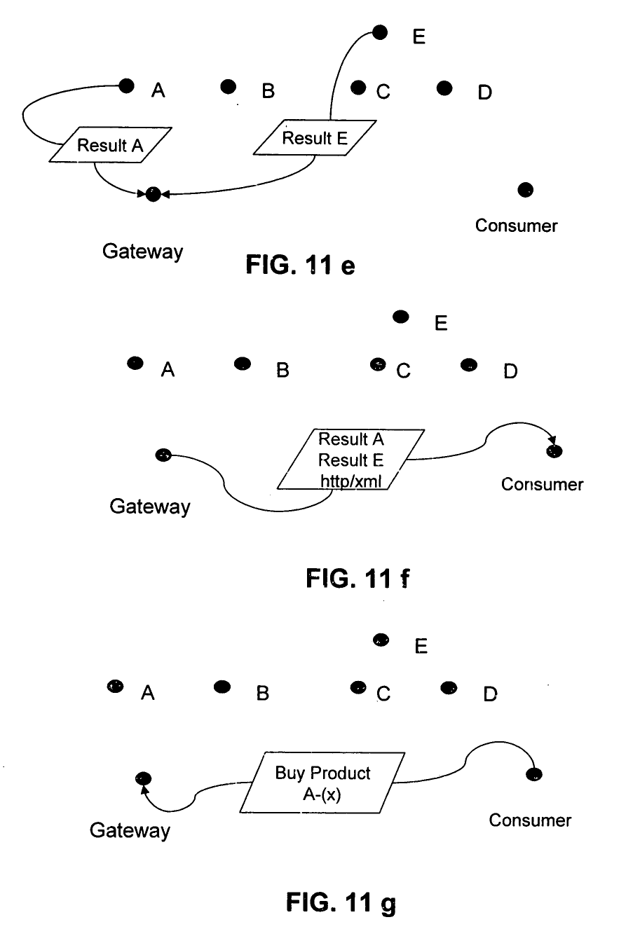

FIGS. 11 a through 11 f illustrate how the network handles a search request from a consumer.

In FIG. 11 a, a consumer sends an http/xml search request to the Gateway 121. This request is created by the consumer application 105 in response to a search initiated by the consumer. The search may be initiated by using key words a drop down menu in the consumer application 105, by manufacturer or any other means for initiating a search for a consumer product. Keyword search is based on the product description listed in the product data files on the manufacturer computer running a manufacturer application. If the product description is blank it will search the meta tag for the file. The Gateway 121 translates the request to Gnutella protocol and sends the request to the available key nodes (in this example A and D) as shown in FIG. 11 b

Nodes A and D receive Gnutella based search request from Gateway 121 and in the case of node A, passes it on to node E or other manufacturer applications 109. The manufacturer applications 109a and 109d in node A and B respectively search their associated product data 252 a and 252 d. If a match is found the results are sent back to gateway 121 with the appropriate search request id (See FIG. 11 e).

As shown in FIG. 11 f, the gateway consolidates the information, and sends the results to the consumer in http/xml format. The consumer can then filter the information based on select product features.

To purchase a product, the consumer will click the buy button associated with the product information received from the search. The consumer application will send an S-http request to the gateway 121 including username/passwords authentication parameters and the relevant product and manufacturer details of the product selected (See FIG. 11 g).

The gateway 121 then processes transaction and sends confirmation back to consumer application for logging through http. Once the buy request is received and validated, the transaction engine logs the details to an internal database, and the details are sent to the relevant consumer and manufacturer application

Consumer-To-Consumer Direct Communication

One of the advantages of the electronic commerce system 101 of the present invention is that it allows consumers to solicit and give feedback on products and services obtained from other consumers. Consumers can solicit any feedback logged by other consumers by sending a search request (Gnutella protocol) across the consumer network using standard Time-To-Live parameters.

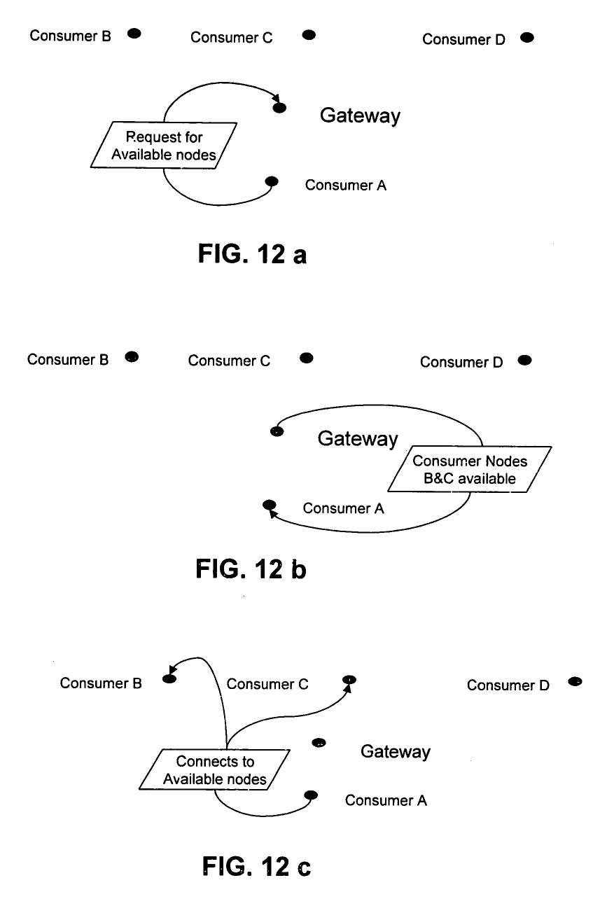

FIGS. 13 a through 13 c illustrate the methodology for this type of consumer to consumer direct communication. In FIG. 12 a consumer A logs on to the Gateway 121 and the consumer application 105 a sends http request to Gateway asking for available consumer nodes. The Gateway 121 searches its database of available consumer nodes and responds to consumer A with the available nodes (See FIG. 12b).

Consumer A then connects to the available nodes and solicits or gives feedback on products and services.

Consider a network with 2,000 manufacturers and the load on the electronic service provider resources should it try to connect to each manufacturer each time a customer request for a product comes in.

The most common way to handle a search is to assemble and index the data beforehand. This is, of course, the answer chosen by search engines as well as by many e-commerce portals. But the solution requires significant server resources, plus the expenditure of computational and networking effort in constant spidering and re-indexing (which also means that changes at the manufacturer end-points are not always immediately reflected in the central search engine). It is not a lightweight solution. Incidentally, indexing would eliminate none of the burden of finding a standard format and harmonizing data. Either the manufacturing end-points or the central server must do this. (Generic Internet search engines make the user do most of it).

The present invention rejects the indexing approach for something simpler and more direct. If it used traditional client/server computing to search 2,000 manufacturers, but without a central index to eliminate unlikely candidates, it would have to send 2,000 requests and handle the responses—and quickly. The networking and computational resources required would be formidable. However, utilizing P2P technology the electronic commerce service provider gateway sends requests only to a small number of sites. These return results (if any that match the customer's request are found), and pass on the identical requests to another set of sites. Each request hops from site to site until it has reached every node (or every relevant node, as will be described momentarily). The electronic commerce service provider Gateway has to handle responses only from sites that have positive results to report.

Efficiency may be further improved by chaining together sites that offer similar products; all consumer device manufacturers, for instance, could be on the same chain, and all automobile dealers on another. The electronic commerce service provider may examine the Schema of each product introduced into the system, and statically assigning the manufacturer a place in the networking chains (that is, making a fixed decision about which manufacturers are chained together). This form of classification has to be done just once for each new product, or perhaps be repeated occasionally to balance an unbalanced network. It is a much more efficient process than continuously searching the Web to feed pages to a web engine and re-indexing the whole network, as traditional search engines do.

From the foregoing it will be appreciated that, although specific embodiments of the invention have been described in this detailed description for the purposes of illustration, various modifications may be made without deviating from the spirit and scope of the invention.

For example The Gnutella protocol is one of many available protocols for effecting peer-to-peer communications. Similarly, http and S-http protocols are standard today but more advanced protocols may be developed and employed in the future in accordance to the teachings of this invention.

What is claimed is:

1. A network for searching and providing content comprising:
a plurality of user computers;
a set of content provider computers, said set of content provider computers comprising at least a first and second subset of content provider computers, and each of said content provider computer including a memory device for storing content;
a gateway;
means associated with each user computer for generating a user search request for content to the gateway;
means associated with the gateway for maintaining a record of the address of each said content provider computers and for routing said search request received from the user computer to each content provider computer in said first subset of content provider computers;
means associated with each content provider computer in said first subset of content provider computers for
effecting a search of the contents of that content provider computer in response to the user search request,
communicating the user search request to said second subset of content provider computers,
creating a message containing the results of the search of its content, and
communicating the message containing the results of the search of its content to the gateway;
means associated with each content provider computer in said second subset of content provider computers for
creating a search result message containing the result of the search of that content provider computer content responsive to said consumer search request, and
routing said search result message to the content provider computer in said first set of content provider computers that forwarded the consumer search request;
means associated with each of the first subset of content provider computers for forwarding the results of the search of the contents of each content provider computer in said second subset of content provider computers to the gateway; and
means associated with the gateway for communicating all results to the user computer originating said user search request.

2. The network of claim 1 wherein said content provider computers are computers that contain manufacturer information available to other manufacturers, and said user computers are operated by manufacturers.

3. The network of claim 1 wherein said content provider computers are computers that contain manufacturer information available to consumers, and said user computers are operated by consumers.

4. The network of claim 1 wherein means associated with each user computer for generating a search request for content to the gateway comprises software that generates an http/xml search request.

5. The network of claim 4 wherein said means associated with the gateway for maintaining a record of the address of a first subset of the content provider computers and for routing said search request received from the user computer to the subset of content provider computer further comprises means for translating the http/xml request to a Gnutella based search request.

6. The network of claim 1 wherein at least one of said plurality of user computers is also a content provider computer.

7. An apparatus for effecting business to consumer electronic commerce comprising:
at least one consumer computer each defining a consumer node;
a first set of merchant computer comprising a plurality of merchant computers each having stored product content and each defining a primary merchant node;
at least one other set of merchant computers comprising a plurality of merchant computers each having stored product content and each defining a secondary merchant node
a gateway;
means associated with said consumer computer for linking to the gateway and for generating a search request for one or more products;
means associated with each of said first set of merchant computers
(a) for linking to the gateway;
(b) for conducting a search of its product content responsive to a search request from the gateway;
(c) for forwarding the search request to one or more of said secondary merchant nodes;
(d) for receiving the results of the search request of the secondary merchant nodes;
(f) for communicating the results of its search and the result of the search request from said secondary merchant nodes to the gateway; and
means associated with the gateway
(a) for receiving a request from the purchaser for information about a desired product
(b) for routing said search request for one or more products to a subset of said set of merchant computers;
(c) for receiving results of the search from each of the merchant computer;
and creating a consolidated search result;
(d) for communicating the consolidated search results to the consumer node originating the search request.

8. The apparatus of claim 7, wherein said apparatus further comprises:
means associated with each consumer computer for sending an order message to the gateway to effect a buy order for a particular product listed in said consolidated search results.

9. The apparatus of claim 7, wherein
the search request for one or more products generated by said means associated with said consumer computer for generating a search request is formatted using a first protocol; and
said means associated with the gateway further comprises means for translating said search request formatted in a first protocol to a search request formatted in a second protocol.

10. The apparatus of claim 9, wherein said first protocol is http/xml and said second protocol is Gnutella.

11. The apparatus of claim 7, wherein said means associated with the gateway further comprise means for communicating to the first set of merchant computers the addresses of the second set of merchant computers that are available for connection

13. A system for use in an electronic commerce transaction conducted over a network, the system comprising:
a plurality of consumer computers
a plurality of content provider computers including data relating to products;
a gateway
means associated with each consumer computer for generating a message to the gateway identifying the address of the consumer computer, and products for which the consumer is requesting information;
means associated with each content provider computer for effecting a search responsive to a consumer message and for generating a message responsive to the consumer message to the consumer;
means associated with the gateway for forwarding the consumer message to a first subset of the plurality of content provider computers each of said content provider computer in said first subset being designated as a first tier node, and for generating instructions to the first subset of content provider computers to forward the consumer message to a second subset of content provider computers.

14. The system as recited in claim 13, further comprising:
means associated with each consumer computer for generating a buy instruction message to a merchant computer.

15. The system as recited in claim 14, further comprising:
means associated with the gateway for generating a buy instruction message to the gateway.

16. The system as recited in claim 13, further comprising:
means associated with the gateway for measuring the time between the forwarding of the consumer message and the time the response of each merchant computer is received by the consumer.

17. The system as recited in claim 16, further comprising:
means associated with the gateway for designating a merchant computer as a first tier node based on the time between the forwarding of the consumer message and the time the response of each merchant computer is received by the consumer.

19. A method for conducting an electronic commerce transaction between parties including a plurality of merchants offering products for sale and a purchaser using a network, the method comprising the steps of:
sending a search request from the purchaser computer to a gateway;
generating a gateway message from the gateway to a first set of merchants said message including the search request from the gateway, the address of the purchaser computer and instructions for each of said first subset of merchants to forward the request to a second subset of merchants;
forwarding the search result of each merchant to the purchaser computer; and
generating a buy instruction from the purchaser computer and communicating the buy instruction to one of said merchants.

20. The method of claim 19, further comprising the step of:
sending a merchant message to the gateway from each of the merchants receiving a gateway message indicating that the gateway message has been received;
measuring the merchant response period between the time the gateway message was sent and the merchant message was received.

21. The method of claim 20 further comprising the step of:
adjusting the members of the first subset of merchants based on the merchant response period.

22. The method of claim 19 further comprising the steps of:
displaying the search results received from all merchants in the purchaser consumer computer display.
